(19) United States
(12) Patent Application Publication
(10) Pub. No.: US 2011/0111229 A1
(43) Pub. Date: May 12, 2011

(54) TERNARY MIXED ETHERS

(76) Inventors: Hartwig Schlesiger, Burscheid (DE); Arne Kull, Bomlitz (DE); Meinolf Brackhagen, Walsrode (DE); Wolfgang Dannhorn, Soltau (DE); Dan Mania, Saline, MI (US)

(21) Appl. No.: 12/741,767

(22) PCT Filed: Oct. 15, 2008
(86) PCT No.: PCT/EP2008/008709

§ 371 Date: Jan. 26, 2011

(30) Foreign Application Priority Data
Nov. 6, 2007 (EP) 07021515.7

(51) Int. Cl. C08B 1/00

(52) U.S. Cl. 428/402; 536/56

(57) ABSTRACT

The invention relates to innovative cellulose derivatives with low surface swelling in aqueous suspension, with high relative high-shear viscosity, and with high thermal flocculation point in water, and also to their use in building-material systems.

The invention relates to innovative cellulose derivatives with low surface swelling in aqueous suspension, with high relative high-shear viscosity, and with high thermal flocculation point in water, and also to their use in dispersion-bound building-material systems, preferably in dispersion-bound paints.

On account of their outstanding properties and their physiological safety, cellulose derivatives are used in a wide variety of applications, for example as thickeners, adhesives, binders, dispersants, water retention agents, protective colloids and stabilizers and also as suspending agents, emulsifiers and film formers.

One field of application for cellulose derivatives is their use as thickeners in emulsion paints. The viscosity of the emulsion paints is generally dependent on the shear rate, the viscosity decreasing as the shear rate goes up. When different cellulose derivatives are compared, a general observation is that, the greater the value of the average chain length of the cellulose chains, the greater the decrease in shear-rate-dependent viscosity in the emulsion paints thickened using them. Therefore, when long-chain cellulose thickeners are used, the viscosity at high shear rate (high-shear viscosity) is generally lower than in the case of those with a shorter cellulose chain length.

As thickeners for emulsion paints use is made in emulsion paints of, in particular, hydroxyethylcellulose (HEC), but also methylhydroxyethylcellulose (MHEC) or methylhydroxypropylcellulose (MHPC).

Given a suitable choice of the degrees of substitution, MHEC and MHPC are insoluble in hot water and can therefore be purified in the course of their preparation, by washing with hot water, to remove salt and other water-soluble by-products. In contrast, HECs are soluble in hot water and can therefore not be purified using hot water to remove salt and other water-soluble by-products.

When these cellulose derivatives are used, a procedure frequently adopted by the user is first to prepare a suspension of the cellulose derivative in water, which is then blended with further constituents of the paint formula. For this purpose the dispersion of the cellulose derivative must be stirrable and pumpable.

So that the cellulose derivatives do not have a spontaneous thickening effect on contact with water, they are generally prepared with retarded dissolution for use in emulsion paints.

This retarded dissolution is generally brought about by means of temporary crosslinking with a dialdehyde such as glyoxal, for example. As a result of the crosslinking the cellulose derivative is water-insoluble to start with, but dissolves in water as a function of the temperature and the pH of the suspension, and then has a thickening effect.

In addition to the retarded dissolution, the water absorption of the cellulose derivative affects the stirrability and pumpability of a cellulose derivative suspension. In this context, water is bound physically by the cellulose derivative, through surface swelling of the cellulose derivative, without the cellulose derivative going into solution. If the surface swelling of the cellulose derivative is high, then the total amount of water of the suspension may be bound, in a specific case, and the stirrability and pumpability of the cellulose derivative suspension are lost.

Although common MHECs are offered in dissolution-retarded form, they nevertheless swell strongly in aqueous suspension. Consequently the stirrability and pumpability of the MHEC suspensions are lost after such a short time. The HECs that are used in emulsion paints do meet the requirements relating to retarded dissolution and low surface swelling in aqueous suspension, but have other disadvantages, such as the afore-mentioned solubility in hot water, and further disadvantages, specified below.

It is true that the surface swelling of MHEC can be influenced subsequently by means of additive treatment steps. Thus, for example, JP 48-34961 describes a thermomechanical treatment of the product at 60-130° C. over a period of 4-15 hours in a closed mixing vessel at 50-200 rpm. This treatment operation, accordingly, is associated, however, with high extra apparatus cost and complexity and also involves much extra time and energy.

A further requirement of the users of cellulose derivatives for the thickening of emulsion paints is a high high-shear viscosity. The viscosity of the emulsion paints is not a constant, but instead alters as a function of the shear rate. As the shear rate goes up, the viscosity falls. In practice this effect is manifested in the fact that, in the state of rest, as for example during storage in the can, a high viscosity value stands for the properties of the emulsion paint, thereby supporting the stability with respect to sedimentation of the fillers and pigments present. In contrast, during processing at relatively high shear with a roller or brush, a significantly lower viscosity value represents the properties of the emulsion paint, allowing rapid and easy processing. The viscosity at high shear rate is referred to here as high-shear viscosity. However, the high-shear viscosity must not be too low, since otherwise a single application of paint does not produce a sufficient coating film thickness. In addition, in the case of excessively low high-shear viscosity, paint splashes may form to an increased extent.

If the viscosity of the emulsion paint is set solely by varying the amount of a particular cellulose derivative used as thickener, the user does not have the possibility to set the high-shear viscosity independently of the overall flow behaviour of the emulsion paint. A higher amount raises the high-shear viscosity, but overall, as a result, the emulsion paint may become too viscous and then no longer has good processing properties, because, for example, the levelling properties become too poor and hence a good surface is not obtained on the coating.

In the prior art there are various known ways of raising the high-shear viscosity without the emulsion paint overall becoming too viscous. They include the combined use of cellulose derivative and synthetic associative thickeners, and the use of associatively thickening cellulose derivatives, the activity of the synthetic associative thickeners and of the associatively thickening cellulose derivatives being greatly influenced by the other constituents of the emulsion paint, such as surfactants, for example. This makes it more difficult to set the viscosity behaviour of the paint, and changes to the formula have severe consequences for the viscosity behaviour.

More rapid determination of a formula is anticipated if the high-shear viscosity is specifically raised by the use of a cellulose derivative of relatively low chain length in a greater amount. This solution to the problem, however, is cost-intensive, since it necessitates a higher quantity of cellulose ether.

The HECs that are used in emulsion paints do not meet the requirements relating to a high high-shear viscosity, while MHECs provide this high high-shear viscosity required by the user.

A further relevant variable for practice is the thermal flocculation point of some cellulose derivatives. The effect of the thermal flocculation point in water is that, above a temperature typical of the cellulose derivative, the cellulose derivative becomes insoluble in water. Since, in the production operation or in the course of subsequent transport, storage or use, emulsions paints may well be exposed to temperatures of up to 65° C., it is important that the flocculation point of the cellulose derivatives is at least greater than 65° C. This ensures sufficient distance from the temperatures typically encountered in practice.

The HECs and MHECs that are used in emulsion paints meet this requirement. HEC does not have a thermal flocculation point in water. The thermal flocculation point of MHEC for emulsions paints is generally above 70° C. However, other cellulose derivatives having a thermal flocculation point in water, such as MHPC, have been unable to achieve broad establishment in the market, since they have a thermal flocculation point of less than 70° C.

The use of MHEHPC is also known to the skilled person. U.S. Pat. No. 3,873,518 describes MHEHPC having a methoxy content of 6-12.5% by weight, a hydroxyethoxy content of 10-22% by weight and a hydroxypropoxy content of 14-32% by weight, and their use as thickeners in emulsion paints. Although they have a flocculation point of greater than 70° C., these products have the same disadvantage as the HECs in relation to a low high-shear viscosity.

EP 0 598 282 describes MHEHPCs having a degree of substitution by hydroxyalkyl groups of less than 0.7, especially less than 0.6, more particularly less than 0.3, and a degree of substitution of methyl groups of 1.6 to 2.5, more particularly 1.8 to 2.4, as thickeners for pickling agents. EP 0 120 430 describes MHEHPCs having a degree of methylation of 0.9 to 2.1, a degree of hydroxy ethylation of 0.2 to 0.5 and a degree of hydroxy propylation of 0.08 to 0.4. These products have a flocculation point of less than 70° C.

Not only the products of EP 0 598 282 but also the products of EP 0 120 430 have a high surface swelling and yield products having a flocculation point <70° C.

Cellulose ethers are obtainable, generally speaking, by alkalifying cellulose with aqueous alkali metal hydroxide solution, reacting the alkalified cellulose with one or more alkylene oxides, and/or with one or more alkyl halides, and separating the resulting cellulose ether from the reaction mixture, if appropriate, cleaning it and drying it, and subjecting it to comminution.

As mentioned, cellulose ethers with retarded dissolution are known per se; cf., for instance, Ullmann's Encyclopaedia of Technical Chemistry, Volume A5, pp. 472-473.

Cellulose ethers with retarded dissolution are prepared in accordance with the prior art, for example, by adding glyoxal to the cellulose ether which has been separated from the reaction mixture and purified, the addition taking place prior to grinding and drying, and carrying out crosslinking. EP 1 316 563 describes a method of this kind for retarding dissolution.

Etherification processes for preparing mixed cellulose ethers are generally prior art and are described for example in EP 1 180 526 and EP 1 279 680.

Since none of the cellulose derivatives known to date meets all of the requirements identified above, there continues to be an urgent need to provide cellulose derivatives which
exhibit low surface swelling in aqueous dispersion, without additional subsequent treatment steps on the powder product;
exhibit a high high-shear viscosity as an aqueous solution; and
have a thermal flocculation point of at least greater than 65° C. in water.

It has now surprisingly been possible to achieve this object by using ternary cellulose derivatives: methylhydroxyethylhydroxypropylcellulose (MHEHPC) with specific substitution in terms of hydroxyethyl groups, hydroxypropyl groups and methyl groups.

In cellulose ether chemistry in general the alkyl substitution is described by the DS. The DS is the average number of substituted OH groups per anhydroglucose unit. The methyl substitution is expressed for example as DS (methyl) or DS (M).

Typically the hydroxyalkyl substitution is described by the MS. The MS is the average number of moles of the etherifying reagent that are bound in ether fashion per mole of anhydroglucose unit. The etherification with the etherifying reagent ethylene oxide is reported, for example, as MS (hydroxyethyl) or MS (HE). Etherification with the etherifying reagent propylene oxide, accordingly, is referred to as MS (hydroxypropyl) or MS (HP).

The determination of the side groups, i.e. with the MS and DS values, is made on the basis of the Zeisel method (reference: G. Bartelmus and R. Ketterer, Z. Anal. Chem. 286 (1977) 161-190).

The invention first provides the MHEHPCs described below.

The MHEHPCs of the invention possess an MS (HE) of 0.10 to 0.70, preferably of 0.15 to 0.70, more preferably of 0.20 to 0.65; an MS (HP) of 0.30 to 1.00, preferably of 0.30 to 0.90, more preferably of 0.35 to 0.80; and a DS (M) of 1.15 to 1.80, preferably of 1.20 to 1.75.

With particular preference the MHEHPCs of the invention possess an MS (HE) of 0.24 to 0.60, more preferably of 0.27 to 0.55, an MS (HP) of 0.41 to 0.75, more preferably of 0.42 to 0.70, and a DS (M) of 1.22 to 1.70, more preferably of 1.25 to 1.65.

With particular preference the MHEHPCs of the invention possess an MS (HE) of 0.29 to 0.50 and an MS (HP) of 0.44 to 0.65 and a DS (M) of 1.30 to 1.60.

The total degree of hydroxy alkylation MS (HA) equals MS (HE) plus MS (HP) of the MHEHPCs of the invention is generally 0.45 to 1.60, preferably 0.55 to 1.5, more preferably 0.65 to 1.4, with particular preference 0.70 to 1.30.

The viscosity of a solution of the MHEHPCs of the invention in water, for an amount of 2% by weight, based on the solution and a shear rate of 2.55 1/s, measured at 20° C., can be 100 to 200 000 mPa·s. Preference is given to using MHEHPC grades having a viscosity of 1000 to 80 000 mPa·s, more preferably over 30 000 to 80 000 mPa·s, with particular preference between 35 000 and 70 000 mPa·s. The range of the HEC products with a low surface swelling that were available to the user was hitherto 3000 to 30 000 mPa·s. By virtue of the MHEHPCs of the invention, the range of higher viscosities, of 30 000 to 80 000 mPa·s, more preferably between 35 000 and 70 000 mPa·s, is now opened up as well. The viscosity is determined by the measurement of an aqueous solution in a Haake Rotovisko VT 550 with a measuring element according to DIN 53019 at 20° C., at the above-specified concentration and at the specified shear rate.

The cellulose ethers of the invention are used typically in the form of powders whose particle size x₅₀ is between 50 and 500 μm. The particle size x₅₀ is defined as the particle size from which 50% by weight of the applied material is less than x and 50% by weight is at least x. Preferably all of the particles pass through a 300 μm sieve, determined in each case by means of sieve analysis in accordance with DIN 66165.

The cellulose ethers of the invention can be used as a mixture or in combination with other cellulose-based thickeners or synthetic thickeners.

The cellulose ethers of the invention are preferably given a dissolution-retarded formulation. This means that the cellulose ethers are temporarily water-insoluble by means, for example, of reversible crosslinking. On contact with water, the cellulose ether particles do not go into solution, but instead can initially be slightly dispersed. Dissolution is then induced, for example, by an increase in temperature or change in pH. One preferred agent for retarding dissolution is glyoxal, which by prior-art methods is incorporated into the cellulose ether or applied to the surface.

The ternary cellulose ethers of the invention exhibit low surface swelling in aqueous dispersion. By surface swelling is meant the physical binding of water by the cellulose derivative, without the cellulose derivative going into solution. In the case of small particles, it is in some cases impossible here to distinguish between surface swelling of the particle and swelling of the particle as a whole.

One particularly practical method of determining the surface swelling, expressed by the swelling value, is to prepare a concentrated, weakly acidic suspension of cellulose ether and then to observe the stirrability. At a slurry concentration of 14 g, preferably of 16 g of cellulose ether/100 ml of water, the products according to the invention are still stirrable for at least one minute. For the method it is necessary to ensure that the physical binding of water is measured. This can be achieved by sufficient retardation of dissolution, by glyoxal crosslinking, for example. Through the setting of a weakly acidic pH, the dissolution of the glyoxal-treated cellulose ether is then prevented. The precise method of determining the swelling value is described in the examples.

The cellulose ethers of the invention generally have a high high-shear viscosity at a shear rate of 500 s⁻¹ (V₅₀₀) of at least 270·x·mPa·s. Here, x is the amount, in % by weight based on the completed solution, that it is necessary to use in order to prepare an aqueous solution of a cellulose ether having a viscosity, at a shear rate of 2.55 s⁻¹ (V_{2.55(x)}), of 9500-10 500 mPa·s. The condition V_{500≧}270·x·mPa·s need not apply throughout the entire range where V_{2.55(x)}=9500 to 10 500 mPa·s. It is sufficient if, for one value x, a viscosity V_{2.55(x)} is obtained which lies within the range from 9500 to 10 500 mPa·s.

The high-shear viscosity here means that the viscosity of the aqueous solution of the cellulose derivative is determined at a shear rate of 500 l/s, the viscosity of this solution at 2.55 1/s having been adjusted through an appropriate amount to 10 000 mPa·s+/−500 mPa·s. It is worth maximizing the high-shear viscosity in the emulsion paint, without the emulsion paint overall becoming too viscous; in other words, the viscosity of the system ought not to be higher than, for example, 9500-10 500 mPa·s.

Since, in the production operation or in the course of subsequent transportation, storage or application, emulsion paints may well be exposed to temperatures up to 65° C., it is highly desirable for the flocculation point of the cellulose derivatives to be at least above 65° C. This ensures a sufficient distance from the temperatures typically encountered in practice. The thermal flocculation point in water means that a cellulose derivative in solution in water departs from the state of dissolution when the temperature of the cellulose ether solution is increased. At this point there are distinct changes in the properties of the cellulose ether/water system. These changes in properties may be measured, for example, by rheology, or optically. The change in the rheological properties in the emulsion paint system may lead, for example, to a destruction of the hitherto stable dispersion, and hence to the paint becoming unusable. The cellulose ethers of the invention have a thermal flocculation point (i.e. flocculation temperature) in water of above 65° C., preferably at least 70° C., more preferably at least 72° C. The precise method of determining the flocculation temperature is described in the examples.

The process of the invention for preparing the new ternary cellulose ethers comprises the following steps:
a) The starting cellulose is alkalified with 1.5 to 5.5 equivalents of alkali metal hydroxide per anhydroglucose unit (AGU), used preferably in the form of an aqueous alkyl metal hydroxide solution,
b) the alkalified cellulose from step a) is reacted with ethylene oxide and propylene oxide at a temperature greater than 65° C. in the presence of a suspension medium which comprises alkyl halide in the amount, calculated according to the following formula, A=[equivalents of alkali metal hydroxide per AGU minus 1.4] to [equivalents of alkali metal hydroxide per AGU plus 0.8],
c) then further alkyl halide is metered in, in an amount B of at least the difference between the amount A of equivalents of alkyl halide per AGU that has already been metered in, and the amount of alkali metal hydroxide per AGU that has been metered in, this amount B being not less than 0.2 equivalent per AGU,
d) if appropriate, further alkali metal hydroxide is added at greater than 65° C., and
e) the resulting alkylhydroxyalkylcellulose is isolated from the reaction product mixture and, if necessary, is cleaned.

Suitable starting material is cellulose in the form of mechanical pulp or cotton linters. The solution viscosity of the etherification products can be varied within wide ranges through a suitable selection of the starting cellulose. Of preferential suitability are ground mechanical pulp and ground linters cellulose or mixtures of these.

The polysaccharides are alkalified (activated) with inorganic bases, preferably with alkali metal hydroxides in aqueous solution, such as sodium hydroxide and potassium hydroxide, preferably with 35% to 60% strength sodium hydroxide solution, more preferably with 48% to 52% strength sodium hydroxide solution.

As suspension media it is possible to use dimethyl ether (DME), C₅-C₁₀ alkanes, such as cyclohexane or pentane, aromatics, such as benzene or toluene, alcohols, such as isopropanol or tert-butanol, ketones such as butanone or pentanone, open-chain or cyclic ethers, such as dimethoxyethane or 1.4-dioxane, for example, and also mixtures of the cited suspension media in varying proportions. The particularly preferred inert suspension may be dimethyl ether (DME).

A general description of the process is given below, using the preferred inert suspension medium DME:

The cellulose used is alkalified with 1.5 to 5.5 eq NaOH per anhydroglucose unit (AGU), preferably with 1.8 to 3.0 eq NaOH per AGU, more preferably with 2.0 to 2.5 eq NaOH per AGU. Generally speaking, the alkalification is carried out at temperatures of 15 to 50° C., preferably around 40° C., and for 20 to 80 minutes, preferably for 30 to 60 minutes. The NaOH is used preferably in the form of a 35 to 60 percent by weight strength aqueous solution, more preferably in the form of 48% to 52% strength sodium hydroxide solution.

Subsequently the resulting alkali metal cellulose is suspended in a mixture of DME and a first amount of methyl chloride (MCl I). The amount of MCL I is characterized as follows, the unit “eq” standing for the molar ratio of the respective ingredient relative to the anhydroglucose unit (AGU) of the cellulose employed:

At least eq MCL I=eq NaOH per AGU minus 1.4, preferably minus 1.0, more preferably minus 0.6, and at most eq MCL I=eq NaOH per AGU plus 0.8, preferably plus 0.5, more preferably plus 0.3.

The preferred amount of MCL I is as follows: at least eq MCL I=eq NaOH per AGU minus 1.0 and also at most eq MCL I=eq NaOH per AGU plus 0.3.

The particularly preferred amount of MCL I is as follows: at least eq MCL I=eq NaOH per AGU minus 0.5 and also at most eq MCL I=eq NaOH per AGU plus 0.1.

The most preferred amount of MCL I is as follows: at least eq MCL I=eq NaOH per AGU minus 0.5 and also at most eq MCL I=eq NaOH per AGU minus 0.1.

The ratio DME/MCL I is generally 90/10 to 30/70 parts by weight, preferably 80/20 to 45/55 parts by weight, and more preferably 75/25 to 60/40 parts by weight.

After the alkali metal cellulose has been suspended in the DME/MCl mixture, the hydroxy alkylating agents, ethylene oxide (EO) and propylene oxide (PO), are metered in and the reaction is forced thermally by heating. The addition of the hydroxy alkylating agents may also take place during the heating phase. The reaction with the hydroxy alkylating agents and MCL I takes place at 60 to 110° C., preferably at 70 to 90° C., more preferably at 75 to 85° C.

Depending on target level of substitution, the amount EO to be used is 0.20 to 3.25 eq per AGU, preferably 0.38 to 1.85 eq per AGU, more preferably 0.48 to 1.30 eq per AGU. The EO is added to the reaction system in one metering step or in portions in two or more metering steps, if appropriate simultaneously or in a mixture with the PO to be metered. Alternatively the addition of EO and PO may also take place in succession, in which case the order may be varied.

Depending on target level of substitution, the amount PO to be used is 0.44 to 4.00 eq per AGU, preferably 0.53 to 2.35 eq per AGU, more preferably 0.63 to 1.50 eq per AGU. The addition of the PO to the reaction system may take place in one metering step or in portions in two or more metering steps; preference is given to metering in one step, if appropriate simultaneously or in a mixture with the EO to be metered.

Maximum preference is given to the continuous addition of a mixture of EO and PO.

Following the first etherification phase, the second amount of methyl chloride (MCL II), needed for the desired substitution with methyl groups, is added without substantial cooling, this second amount being characterized as follows: at least eq MCL II=eq NaOH minus eq MCL I plus 0.3, or at least eq MCL II=0.2 eq MCL per AGU, if the amount of MCL II as calculated by the preceding formula is less than 0.2 eq MCL per AGU. Preference is given to using eq MCL II=1 to 3.5 eq MCL per AGU, more preferably eq MCL II=1.5 to 2.5 eq MCL per AGU. The amount of MCL II is added at a temperature greater than 65° C., preferably at 75 to 90° C., or at the temperature which prevails at the end of the hydroxy alkylation phase.

Subsequently, in order to set a high DS (M), optionally, a further amount of alkali metal hydroxide is metered in as an aqueous solution, without substantial cooling. It is preferred to use NaOH in the form of a 35 to 60 percent by weight strength aqueous solution, more preferably in the form of 48% to 52% strength sodium hydroxide solution. It is preferred to use 0.2 to 1.9 eq NaOH II per AGU as a subsequent addition; with particular preference 0.4 to 1.5 eq NaOH II per AGU is used as a subsequent addition; most preferably 0.6 to 1.1 eq NaOH II per AGU is used as a subsequent addition.

After the end of the second etherification phase, all of the volatile constituents are separated off by distillation, using reduced pressure if appropriate. The purification, drying and grinding of the resultant product take place in accordance with the prior-art methods typical in cellulose derivative technology.

### EXAMPLES

The flocculation temperature is determined as follows: an aqueous test solution containing 0.1% by weight, based on the completed solution, of cellulose ether is heated to a temperature of greater than 95° C. with a heating rate of 2° C./min and with stirring (magnetic stirrer). The apparatus used is a circulation thermostat with a temperature program setter, cooling assembly and heat transfer medium for temperatures from 20 to 130° C., and also a temperature-controllable stirring vessel with double jacket, this vessel being attached to the thermostat. The clouding caused by flocculation of the cellulose ether is measured by way of the light absorption at 450 nm, using a waveguide photometer 662 (Metrohm), and is recorded against the temperature of the solution. The branch of the plot for increasing temperature generally has a relatively sharp kink, which marks the flocculation point and hence the flocculation temperature. One tangent is close to the baseline, and another through the point of inflection of the absorbance temperature curve. At the point of insertion of the tangents, the flocculation temperature is read off to 0.1° C. From experience the error range is approximately ±0.3-±0.5° C.

The viscosity is determined by the measurement of an aqueous solution in a Haake Rotovisko VT 550 having a measuring element according to DIN 53019 at 20° C., at the concentrations stated in each case and with the shear rates stated in each case.

The swelling value is determined as follows: 0.200 g of NaH₂PO₄ is dissolved completely (visual check) within about 3 minutes in a 400 ml glass beaker (high form) with 100.00 g of tap water. The solution is stirred at room temperature of 20+/−0.5° C. using a commercial magnetic stirrer (e.g. from IKA: IKA RET basic or IKAMAG RET) initially at 500 rpm, using a commercial, Teflon-coated magnetic stirring rod (40×8 mm). Thereafter, at a time t=0 (stopwatch), first 2.000 g of the glyoxal-treated cellulose ether under investigation are added rapidly in the middle of the glass beaker surface. The cellulose ether is treated with glyoxal, in accordance with the process according to Example 5, pages 4-5 of EP1316563A1. Then, every 60 seconds, a further 2.000 g of cellulose ether are added, the speed of the magnetic stirrer being adjusted, i.e. increased. The test is discontinued when the suspension is no longer stirrable. This is the case when the cellulose ether remains lying on the surface for longer than 1 minute at least in some cases. The maximum amount of cellulose ether which is dispersible, i.e. still stirrable, corresponds to the sum of the amount of cellulose ether added stepwise, up to and including the last amount added, which was incorporated completely by stirring. A proportional amount added which may also have been dispersed, although the remainder of the amount added could no longer be incorporated by stirring, is disregarded. After 14 g, preferably 16 g, have been added, the test is ended. In this case the swelling is sufficiently low.

### Examples in Relation to Flocculation Temperature and Swelling

From Inventive Examples 4 to 9 and Comparative Examples 1 to 3 and 10 to 12 below it is evident that the MHEHPCs of the invention have not only a sufficiently high flocculation temperature but also good swelling values.

| | | | | | Flocculation | |
|---|---|---|---|---|---|---|
| | DS | MS | MS | V2 | temperature | Swelling |
| Example | M | HE | HP | mPa · s | ° C. | value g |
| Comp. | 1.1 | 0 | 1.04 | 37 000 | 65 | 12 |
| Ex. 1 | | | | | | |
| Comp. | 1.1 | 0.13 | 1.12 | 34 000 | 65 | ≧16 |
| Ex. 2 | | | | | | |
| Comp. | 1.41 | 0 | 0.4 | 39 600 | 69 | 10 |
| Ex. 3 | | | | | | |
| Inv. | 1.42 | 0.11 | 0.42 | 38 700 | 70 | 14 |
| Ex. 4 | | | | | | |
| Inv. | 1.42 | 0.25 | 0.41 | 37 800 | 72 | ≧16 |
| Ex. 5 | | | | | | |
| Inv. | 1.44 | 0.37 | 0.45 | 67 300 | 73 | ≧16 |
| Ex. 6 | | | | | | |
| Inv. | 1.41 | 0.39 | 0.43 | 38 200 | 74 | ≧16 |
| Ex. 7 | | | | | | |
| Inv. | 1.35 | 0.40 | 0.48 | 56 100 | 76 | ≧16 |
| Ex. 8 | | | | | | |
| Inv. | 1.22 | 0.44 | 0.57 | 55 100 | 80 | ≧16 |
| Ex. 9 | | | | | | |
| Comp. | 1.33 | 0.32 | 0.18 | 81 000 | 84 | 6 |
| Ex. 10 | | | | | | |
| Comp. | 1.34 | 0.31 | 0.09 | 85 000 | 86 | 10 |
| Ex. 11 | | | | | | |
| Comp. | 1.36 | 0.32 | 0 | 92 000 | 91 | 8 |
| Ex. 12 | | | | | | |

Similarly good swelling values are achieved by hydroxyethylcellulose (HEC) and ethylhydroxyethylcellulose (EHEC). These, however, have a low high-shear viscosity.

### Examples Relating to High-Shear Viscosity

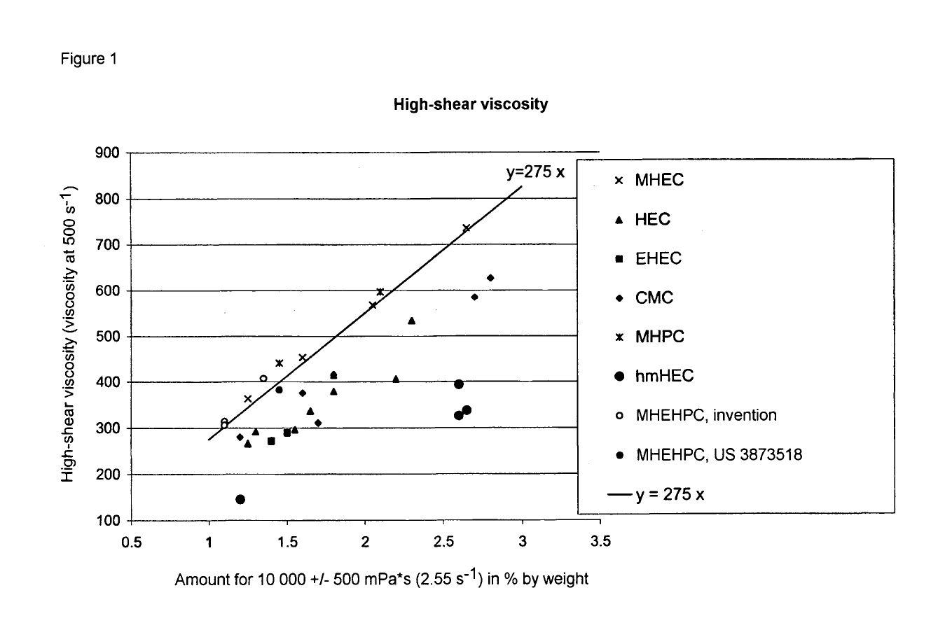

In FIG. 1 it is apparent that HEC, hmHEC (hydrophobically modified HEC), CMC and EHEC exhibit the disadvantage of a lower high-shear viscosity as compared with MHEC and MHPC and also with the inventive MHEHPC.

| | | Viscosity at | | | |
|---|---|---|---|---|---|
| | | shear rate | | | |
| | Conc. | | 500 | | |
| | % by | 2.55 s − 1 | s − 1 | z = | |
| | weight | mPa · s | mPa · s | V₅₀₀/x | |
| Sample | x | V_{2.55} | V₅₀₀ | z | z ≧ 270 |
| MHEC (Comparative) | | | | | |
| MT 4000 PV, 4C174 | 2.65 | 9 780 | 736 | 278 | Y |
| MT 10 000 PV, 31072 | 2.05 | 10 060 | 568 | 277 | Y |
| MT 20 000 PV, 4A010 | 1.60 | 9 890 | 453 | 283 | Y |
| MT 40 000 PV, 4E293 | 1.25 | 9 870 | 363 | 290 | Y |
| Tylose MH 30 000 | 1.60 | 10 846 | 559 | 349 | Y |
| YP2 #6342 | | | | | |
| MHPC (Comparative) | | | | | |
| Methocel J 75 MS | 1.45 | 9 995 | 441 | 304 | Y |
| Methocel 366 | 2.10 | 10 430 | 597 | 284 | Y |
| HEC (Comparative) | | | | | |
| Natrosol 250 MBR, | 2.20 | 10 180 | 406 | 185 | N |
| #6237 | | | | | |
| Natrosol 250 HER, | 1.55 | 10 160 | 296 | 191 | N |
| #6238 | | | | | |
| Natrosol 250 H4BR, | 1.40 | 9 740 | 273 | 195 | N |
| #6278 | | | | | |
| Natrosol 250 HHR, | 1.25 | 9 430 | 266 | 213 | N |
| #6279 | | | | | |
| Natrosol 250 HR, | 1.65 | 10 080 | 336 | 204 | N |
| #6280 | | | | | |
| Cellosize QP 15 000 | 1.80 | 9 575 | 379 | 211 | N |
| Tylose H 6000 | 2.30 | 10 520 | 534 | 232 | N |
| YP2 | | | | | |
| Tylose H 30 000 | 1.80 | 10 040 | 415 | 230 | N |
| YP2 | | | | | |
| Tylose H 100 000 | 1.30 | 9 996 | 292 | 225 | N |
| YP2 | | | | | |
| EHEC (Comparative) | | | | | |
| Bemocoli EBS 451 | 1.50 | 10 070 | 289 | 193 | N |
| FQ | | | | | |
| Bemocoli EBS 481 | 1.40 | 9 857 | 272 | 194 | N |
| FQ | | | | | |
| CMC (Comparative) | | | | | |
| CRT 40 000 PV | 1.20 | 10 236 | 280 | 233 | N |
| CRT 20 000 PV | 1.70 | 9 890 | 310 | 183 | N |
| CRT 10 000 PV | 1.80 | 9 809 | 416 | 231 | N |
| CRT 3000 PV | 2.80 | 10 170 | 626 | 224 | N |
| Celflow S-200 | 1.60 | 10 471 | 375 | 234 | N |
| Celflow S-50 | 2.70 | 10 006 | 584 | 216 | N |
| hmHEC (Comparative) | | | | | |
| Natrosol plus 330 | 2.60 | 9.030 | 325 | 125 | N |
| PA/1 (TCS) | | | | | |
| Natrosol plus 330 | 2.65 | 9 693 | 337 | 127 | N |
| PA/2 (TCS) | | | | | |
| Natrosol plus 330 | 2.60 | 10 380 | 393 | 151 | N |
| CS | | | | | |
| Natrosol plus 430 | 1.20 | 9 873 | 145 | 121 | N |
| PA | | | | | |
| Tylose E 60210 | 2.50 | 9 681 | 371 | 148 | N |
| Tylose E 60302 | 1.50 | 9 929 | 233 | 155 | N |
| MHEHPC | | | | | |
| Inv. Ex. 5 | 1.35 | 11 160 | 407 | 302 | Y |
| Inv. Ex. 8 | 1.10 | 9 712 | 314 | 285 | Y |
| Inv. Ex. 9 | 1.10 | 10 250 | 306 | 278 | Y |
| Comp. Ex. 13 | 1.45 | 9 730 | 382 | 263 | N |

Comparative Example 13, in accordance with U.S. Pat. No. 3,873,518 (Strange et al.), and the inventive MHEHPCs have the following degrees of substitution:

| Example | DS M | MS HE | MS HP |
|---|---|---|---|
| Inv. Ex. 5 | 1.42 | 0.25 | 0.41 |
| Inv. Ex. 8 | 1.35 | 0.40 | 0.48 |
| Inv. Ex. 9 | 1.22 | 0.44 | 0.57 |
| Comp. Ex. 13 | 1.12 | 0.5 | 1.05 |

### Preparation Example

In a 400 l autoclave, 24.7 kg of ground mechanical pulp and 10.4 kg of ground cotton linters are rendered inert by evacuation and blanketing with nitrogen. Subsequently a mixture of 57.4 kg of dimethyl ether and 1.9 mol eq of chloromethane is metered into the reactor. Then 2.2 mol eq of sodium hydroxide in the form of 50% strength by weight aqueous sodium hydroxide solution are sprayed onto the cellulose, with mixing, over about 10 minutes. Throughout the reaction phase the reaction system continues to be mixed. Alkalification is carried out for a further 35 minutes. The metering of the hydroxide solution and the subsequent alkalification proceed subject to a temperature increase from about 25° C. to about 40° C. Then 0.60 mol eq of ethylene oxide is metered into the reactor over about 30 minutes. Subsequently 1.05 mol eq of propylene oxide are metered into the reactor over about 35 minutes. During the metered addition of the alkylene oxides, the mixture is heated slowly to about 80° C. When mixing has been carried out at this temperature for a further 40 minutes, heating takes place to about 85° C. over 15 minutes, and then 2.20 mol eq of methyl chloride are metered into the reactor over 10 minutes. Subsequently reaction is continued at this temperature for 50 minutes more. Thereafter the volatile constituents are distilled off and the reactor is evacuated.

The crude product is subjected to washing with hot water, then to dry granulation and grinding. During the granulating step, 1% by weight of glyoxal, based on the dry MHEHPC mass, is incorporated.

The degree of substitution of the resulting methylhydroxyethylhydroxypropylcellulose by methyl groups (DS M) was 1.41, the degree of substitution by hydroxyethyl groups (MS HE) was 0.39, and the degree of substitution by hydroxypropyl groups (MS HP) was 0.43.

The viscosity of the solution of this cellulose ether in water, the amount used being 2% by weight, at a shear rate of 2.55 1/s, measured at 20° C., was 38 200 mPa·s.

1. Methylhydroxyethylhydroxypropylcellulose characterized by an MS (HE) of 0.10 to 0.70, an MS (HP) of 0.30 to 1.00, and a DS (M) of 1.15 to 1.80.

2. Methylhydroxyethylhydroxypropylcellulose according to claim 1, having a viscosity in the range between 100 and 200 000 mPa·s.

3. Methylhydroxyethylhydroxypropylcellulose according to claim 1, the total degree of hydroxy alkylation MS (HE)+MS (HP) being 0.45 to 1.60.

4. Methylhydroxyethylhydroxypropylcellulose according to claim 1 being present in powdered form with a particle size between 50 and 500 μm.

5. Methylhydroxyethylhydroxypropylcellulose according to claim 1 having a swelling value of at least 14 g.

6. Methylhydroxyethylhydroxypropylcellulose according to claim 1 having a flocculation temperature of above 65° C.

7. Methylhydroxyethylhydroxypropylcellulose according to claim 6, having a high-shear viscosity of V₅₀₀≧270·x·mPa·s, x indicating the amount of methylhydroxyethylhydroxypropylcellulos, in % by weight based on the completed solution, needed to prepare an aqueous methylhydroxyethylhydroxypropylcellulose solution having a viscosity, at a shear rate of 2.55 s⁻¹ (V_{2.55(x)}), of 9500-10 500 mPa·s.

8. Process for preparing a methylhydroxyethylhydroxypropylcellulose according to claim 1, wherein
a) the starting cellulose is alkalified with 1.5 to 5.5 equivalents of alkali metal hydroxide per AGU,
b) the alkalified cellulose from step a) is reacted with ethylene oxide and propylene oxide at a temperature greater than 65° C. in the presence of a suspension medium which comprises alkyl halide in an amount A=[equivalents of alkali metal hydroxide per AGU minus 1.4] to [equivalents of alkali metal hydroxide per AGU plus 0.8],
c) then further alkyl halide is metered in, in an amount B of at least the difference between the amount A of equivalents of alkyl halide per AGU that has already been metered in, and the amount of alkali metal hydroxide per AGU that has been metered in, this amount B being not less than 0.2 equivalent per AGU,
d) if appropriate, further alkali metal hydroxide is added at greater than 65° C., and
e) the resulting methylhydroxyethylhydroxypropylcellulose is isolated from the reaction product mixture and, if necessary, is cleaned.

9. (canceled)

10. Methylhydroxyethylhydroxypropylcellulose according to claim 1 characterized by an MS (HE) of 0.29 to 0.50, an MS (HP) of 0.44 to 0.65, and a DS (M) of 1.3 to 1.6.

11. Methylhydroxyethylhydroxypropylcellulose according to claim 10, having a viscosity in the range between 100 and 200 000 mPa·s.

12. Methylhydroxyethylhydroxypropylcellulose according to claim 10 being present in powdered form with a particle size between 50 and 500 μm.

13. Methylhydroxyethylhydroxypropylcellulose according to claim 10, the MHEHPC having a swelling value of at least 14 g.

14. Methylhydroxyethylhydroxypropylcellulose according to claim 10 having a flocculation temperature of above 65° C.

15. Methylhydroxyethylhydroxypropylcellulose according to claim 14, having a high-shear viscosity of V₅₀₀≧270·x·mPa·s, x indicating the amount of methylhydroxyethylhydroxypropylcellulose, in % by weight based on the completed solution, needed to prepare an aqueous methylhydroxyethylhydroxypropylcellulose solution having a viscosity, at a shear rate of 2.55 s⁻¹ (V_{2.55(x)}), of 9500-10 500 mPa·s.

16. Dispersion-bound building-material system comprising the methylhydroxyethylhydroxypropylcellulose according to claim 1.

17. Dispersion-bound building-material system comprising the methylhydroxyethylhydroxypropylcellulose according to claim 10.
